(19) United States
(12) Patent Application Publication
(10) Pub. No.: US 2007/0156500 A1
(43) Pub. Date: Jul. 5, 2007

(54) Architectural design for sell from stock application software

(76) Inventors: Wilfried Merkel, Heidelberg (DE); Thomas Bach, Muehlhausen (DE); Cordula Ude, Muehlhausen (DE); Katja Kasteleiner, Mannheim (DE); Peer Marschall, Heidelberg (DE); Tao Yu, Walldorf (DE); Rainer Heun, Schwetzingen (DE); Stefan Adelmann, Mannheim (DE); Andrea Sudbrack, Heidelberg (DE); Georg Podhajsky, Phillppsburg-Rheinsheim (DE); Thomas Nitschke, Nussloch (DE); Stefan Franke, Buxtehude (DE); Andreas Poth, Weingarten (DE); Jochen Wickel, Wiesloch (DE); Stephan Hetzer, Oestringen-Eichelberg (DE); Jochen Hirth, Birkenau (DE); Michael Picht, Walldorf (DE); Jochen Steinbach, Bad Schoenborn (DE); Achim Heger, Leimen-Gauangelloch (DE); Dietmar Nowotny, Dielheim (DE); Martin von der Emde, Wiesloch (DE); Joachim Kenntner, Heidelberg (DE); Daniel Bock, Heidelberg (DE); Uwe Mayer, Erligheim (DE); Ralf Reinke, Rauenberg (DE); Wilhelm Zwerger, Stutensee-BL (DE); Gunther Liebich, Walldorf (DE); Holger Herrmann, Malsch (DE); Jens Freund, Heidelberg (DE); Stefan Kaetker, Dossenheim (DE); Gerd Moosmann, Pforzheim (DE); Peter Latocha, Malsch (DE)

Correspondence Address: FISH & RICHARDSON, P.C., PO BOX 1022, MINNEAPOLIS, MN, 55440-1022, US

(21) Appl. No.: 11/322,611

(22) Filed: Dec. 30, 2005

(51) Int. Cl. G06F 15/02; G06F 9/46

(52) U.S. Cl. 705/9

(57) ABSTRACT

Methods, systems, and apparatus, including computer program products, for implementing a software architecture design for a software application implementing sell from stock software useful to process quotations, capture orders, process delivery and invoice. The application is structured as multiple process components interacting with each other through service interfaces, and multiple service interface operations, each being implemented for a respective process component. The process components include an Outbound Delivery process component, a Site Logistics Processing process component, a Confirmation and Inventory process component, a Customer Requirement Processing process component, a Supply and Demand Matching process component, a Logistics Execution Control process component, a Customer Quote Processing process component, a Sales Order Processing process component, and a Sales Contract Processing process component.

### BACKGROUND

The subject matter of this patent application relates to computer software architecture, and more particularly to the architecture of application software for Sell From Stock.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a software application.

The invention can be implemented as methods, systems, and apparatus, including computer program products, for implementing a software architecture design for a software application implementing sell from stock software useful to process quotations, capture orders, process delivery and invoice. The application is structured as multiple process components interacting with each other through service interfaces, and multiple service interface operations, each being implemented for a respective process component. The process components include an Outbound Delivery process component, a Site Logistics Processing process component, a Confirmation and Inventory process component, a Customer Requirement Processing process component, a Supply and Demand Matching process component, a Logistics Execution Control process component, a Customer Quote Processing process component, a Sales Order Processing process component, and a Sales Contract Processing process component.

The invention can further be implemented as methods, systems, and apparatus, including computer program products, implementing a software architecture design for a software application that is adapted to interact with external software systems through the service operations described in reference to external process components, or a subcombination of them.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a sell from stock software application.

FIG. 2 illustrates the elements of the architecture as they are drawn in the figures of this patent application.

FIG. 3 is a block diagram showing interactions between a Bank Statement Creation at Bank process component and a Payment Processing process component.

FIG. 4 is a block diagram showing interactions between a Sales Order Processing process component and a Product Valuation Accounting process component.

FIG. 5 is a block diagram showing interactions between a Payment Processing process component and an Accounting process component.

FIG. 6 is a block diagram showing interactions between a Due Item Processing process component and an Accounting process component.

FIG. 7 is a block diagram showing interactions between a Customer Invoice Processing process component and a Supplier Invoice Processing at Customer process component.

FIG. 8 is a block diagram showing interactions between a Logistics Execution Control process component and an Outbound Delivery Processing process component.

FIG. 9 is a block diagram showing interactions between an Outbound Delivery Processing process component and a Customer Invoice Processing process component.

FIG. 10 is a block diagram showing interactions between a Sales Order Processing process component and a Customer Invoice Processing process component.

FIG. 11 is a block diagram showing interactions between a Payment Processing process component and a Processing at Business Partner process component.

FIG. 12 is a block diagram showing interactions between a Customer Invoice Processing process component and an Accounting process component.

FIG. 13 is a block diagram showing interactions between a Payment Processing process component and a Payment Order processing at house bank process component.

FIG. 14 is a block diagram showing interactions between a Sales Order Processing process component and an Accounting process component.

FIG. 15 is a block diagram showing interactions between a Payment Processing process component and a Due Item Processing process component.

FIG. 16 is a block diagram showing interactions between a Logistics Execution Control process component and a Site Logistics process component.

FIG. 17 is a block diagram showing interactions between a Sales Order Processing process component and a Customer Requirement Processing process component.

FIG. 18 is a block diagram showing interactions between an Outbound Delivery Processing process component and an Inbound Delivery Processing at Customer process component.

FIG. 19 is a block diagram showing interactions between a Site Logistics Processing process component and an Accounting process component.

FIG. 20 is a block diagram showing interactions between a Customer Quote Processing process component and a Customer Requirement Processing process component.

FIG. 21 is a block diagram showing interactions between a Due Item Processing process component and a Payment Processing process component.

FIG. 22 is a block diagram showing interactions between a Purchase Order Processing at Customer process component and a Sales Order Processing process component.

FIG. 23 is a block diagram showing interactions between a Customer Invoice Processing process component and a Due Item Processing process component.

FIG. 24 is a block diagram showing interactions between a Payment Processing at Business Partner process component and a Payment Processing process component.

Like reference numbers and designations in the various drawings indicate like elements.

### DETAILED DESCRIPTION

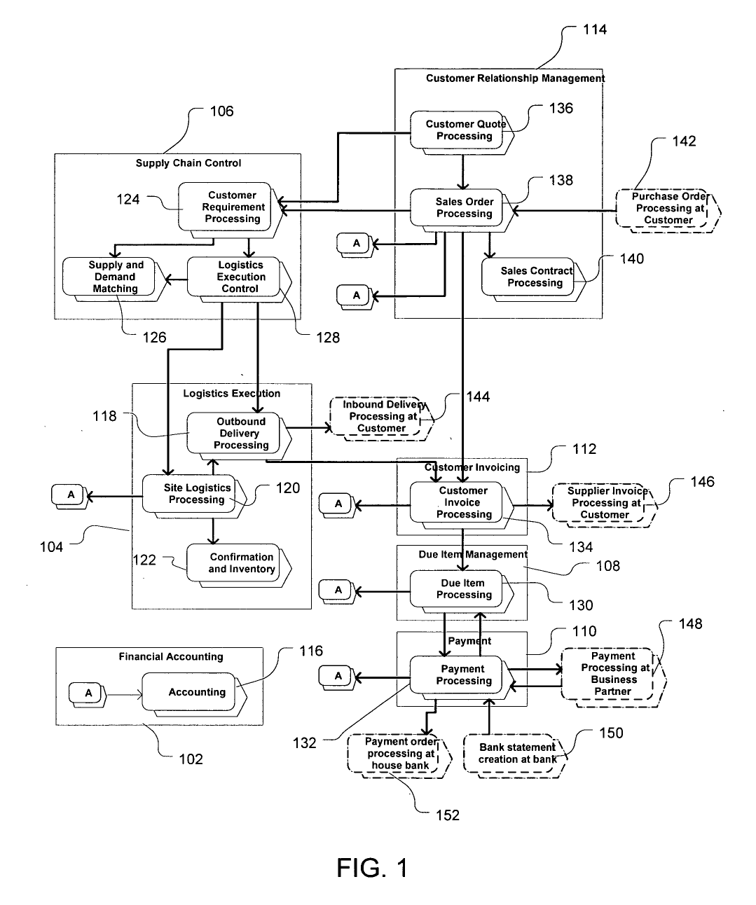

FIG. 1 shows the software architectural design for a sell from stock software application. The sell from stock application is software that implements an end-to-end process used to process quotations, capture orders, process delivery and invoice.

As shown in FIG. 1, the Sell From Stock design includes seven deployment units: a Financial Accounting unit 102, a Logistics Execution unit 104, a Supply Chain Control unit 106, a Due Item Management unit 108, a Payment unit 110, a Customer Invoicing unit 112 and a Customer Relationship Management unit 114.

The Financial Accounting deployment unit 102 contains an Accounting process component 116 that records all relevant business transactions.

The Logistics Execution deployment unit 104 includes three process components: an Outbound Delivery process component 118, a Site Logistics Processing process component 120 and a Confirmation and Inventory process component 122.

The Outbound Delivery process component 118 combines tasks concerning outbound delivery processes and enables communication with a vendor and a process component within the Invoice deployment unit. For example, the Outbound Delivery process component 118 may prepare and trigger execution of physical operations associated with an invoice.

The Site Logistics Processing process component 120 supports all preparation and execution tasks concerning internal inventory movement in a warehouse type environment. The Site Logistics Processing process component 120 may provide stock information such as special stock items. Exception and alert information may also be provided by the Site Logistics Processing process component 120.

The Confirmation and Inventory process component 122 combines all tasks required to confirm inventory changes and provided activities. The Confirmation and Inventory process component 122 may provide services to maintain current stock, handling unit content, logistics operating unit content and allocation content.

The Supply Chain Control deployment unit 106 includes three process components: a Customer Requirement Processing process component 124, a Supply and Demand Matching process component 126, and a Logistics Execution Control process component 128.

The Customer Requirement Processing process component 124 combines the tasks required for processing customer requirements and provides an interface to presales, sales and services. It receives the customer requirements, prepares them and passes them on to Supply and Demand Matching as supply planning requirements.

The Supply and Demand Matching process component 126 combines all the tasks necessary to ensure that sufficient material receipt elements exist to cover material demand while taking available capacity into account. For example, the supply and demand matching component may collect all the various material demands from customer requirement processing, the in-house requirement processing, the demand forecast processing, and the sales scheduling agreement processing and attempt to assign all the existing material receipts. The matching component may also plan the internal or external procurement of further material receipts where necessary.

The Logistics Execution Control process component 128 controls and monitors the supply chain execution activities necessary for the fulfillment of an order. For example, sales order activities or purchase order activities may be controlled and monitored by the logistics execution control process component. The Logistics Execution Control process component 128 sends information to the logistics execution to trigger the necessary supply chain execution activities, receives information about the supply chain execution progress, and updates data relevant for both fulfillment and supply and demand planning.

The Due Item Management deployment unit 108 includes a Due Item Processing process component 130. The Due Item Processing process component 130 is used to manage all payables, receivables from service and supply and corresponding sales including a withholding tax.

The Payment deployment unit 110 includes a Payment Processing process component 132. The Payment Processing process component 132 is used to handle all incoming and outgoing payments as well as represent the main database for a liquidity status.

The Customer Invoice deployment unit 112 includes a Customer Invoice Processing process component 134 used to charge a customer for the delivery of goods or services The Customer Relationship Management deployment unit 114 includes three process components: a Customer Quote Processing process component 136, a Sales Order Processing process component 138, and a Sales Contract Processing process component 140.

The Customer Quote Processing process component 136 is used to offer a customer a delivery of goods or services according to fixed terms. The offer is legally binding for a certain period of time.

The Sales Order Processing process component 138 handles customers' requests to a company for delivery of goods or services at a certain time. The request is received by a sales area that is then responsible for fulfilling the contract.

The Sales Contract Processing process component 140 is used to handle sales agreements that contain special conditions negotiated between the vendor and a customer.

A number of external process components, described below, will be used to describe the architectural design. These include a Purchase Order Processing at Customer process component 142, an Inbound Delivery Processing at Customer process component 144, a Supplier Invoice Processing at Customer process component 146, a Payment Processing at Business Partner process component 148, a Bank statement create at bank process component 150, and a Payment order processing at house bank process component 152.

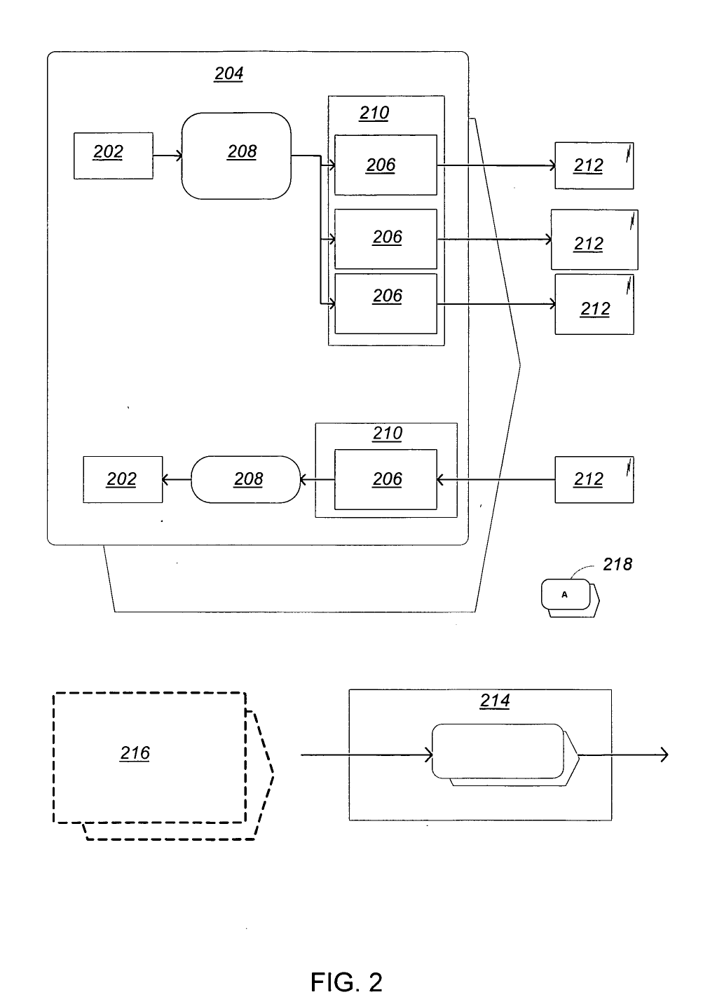

FIG. 2 illustrates the elements of the architecture as they are drawn in the figures of this patent application. The elements of the architecture include the business object (drawn as icon 202), the process component (drawn as icon 204), the operation (drawn as icon 206), the process agent (drawn as icon 208), the service interface or interface (drawn as icon 210), the message (drawn as icon 212), and the deployment unit (drawn as icon 214).

Not explicitly represented in the figures is a foundation layer that contains all fundamental entities that are used in multiple deployment units. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are assigned to their respective deployment unit.

A process component of an external system is drawn as a dashed-line process component (drawn as icon 216). Such a process component may be referred to as an external process component, and it is used to represent the external system in describing interactions with the external system; however, this should be understood to require no more of the external system that it be able to produce and receive messages as required by the process component that interacts with the external system.

The connector icon 218 is used to simplify the drawing of interactions between process components.

The connector icon 218 is used to simplify the drawing of interactions between process components.

Interactions between process component pairs involving their respective business objects, process agents, operations, interfaces, and messages are described as process component interactions, which determine the interactions of a pair of process components across a deployment unit boundary, i.e., from one deployment unit to another deployment unit. Interactions between process components are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the FIGS. of this patent application; these figures will show the relevant elements associated with potential interaction between two process components, but interfaces, process agents, and business objects that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. A process component is a software package that realizes a business process and generally exposes its functionality as services. The functionality contains business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters serving as a signature.

The architectural elements also include the service interface, referred to simply as the interface. An interface is a named group of operations. Each operation belongs to exactly one interface. An interface belongs to exactly one process component. A process component might contain multiple interfaces. In one implementation, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An output process agent will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement supports the operations of the original.

Interactions Between Process Components “Bank Statement Creation at Bank” and “Payment Processing”

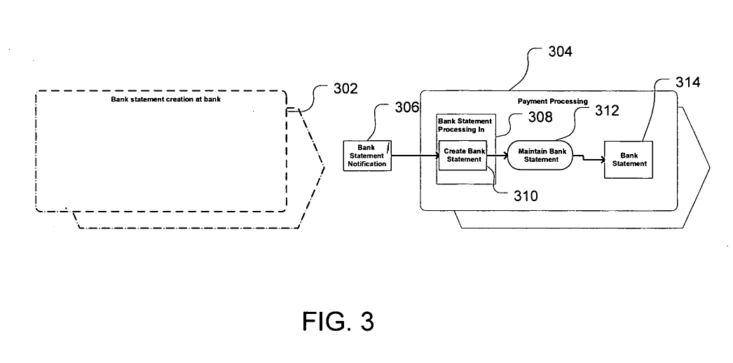

FIG. 3 is a block diagram showing interactions between a Bank Statement Creation at Bank process component 302 and a Payment Processing process component 304 in the architectural design of FIG. 1.

The bank statement is created at a bank and a Bank Statement Notification message 306 is generated. The Payment Processing process component 304 receives the Bank Statement Notification message 306 into the Bank Statement Processing In interface 308 where a Create Bank Statement operation 310 is invoked to create a bank statement in the Payment Processing process component 304. A Maintain Bank Statement inbound process agent 312 updates the Bank Statement business object 314 with a new or modified bank statement. For example, the bank statement may be a statement for a house bank account where modifications are made when bills are paid.

Interactions Between Process Components “Sales Order Processing” and “Product Valuation Accounting”

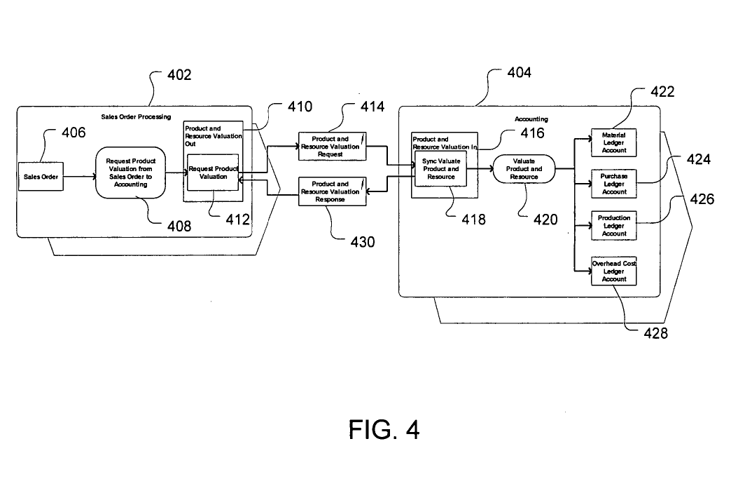

FIG. 4 is a block diagram showing interactions between a Sales Order Processing process component 402 and a Product Valuation Accounting process component 404 in the architectural design of FIG. 1. The Purchase Order Process component 402 includes a Sales Order business object 406, which passes information into a Request Product Valuation from Sales Order to Accounting outbound process agent 408. The information may contain notifications about created, changed or cancelled sales orders.

The outbound process agent 408 sends notification into a Product Valuation Out interface 410 which includes a synchronous Request Product Valuation operation 412. A Product Valuation Request message 414 may then be sent to the Product Valuation Accounting process component 404.

The Product Valuation Accounting process component 404 receives the request message in the interface Product and Resource Valuation In interface 416 where a synchronous Valuate Product operation 418 may be invoked. Upon completion of the operation 418, a Valuate Product and Resource inbound process agent 420 may update one or all of four business objects: a Material Ledger Account business object 422, a Purchase Ledger Account business object 424, a Production Ledger Account business object 426, or an Overhead Cost Ledger business object 428. The Material Ledger Account business object 422 is a record of the quantities, values, and prices for materials in a company that are relevant to valuation. The Purchase Ledger Account business object 424 in a process subledger account is a view of purchasing activities defined for financial accounting purposes. The Production Ledger Account business object 426 is a view of production related business transactions defined for financial accounting purposes. The Overhead Cost Ledger business object 428 is a record of the costs incurred by the provision of resources. Additionally, the Valuate Product operation 418 may send a Product and Resource valuation Response message 430 to the Request Product Valuation operation 412 after the message 414 is received.

Interactions Between Process Components “Payment Processing” and “Accounting”

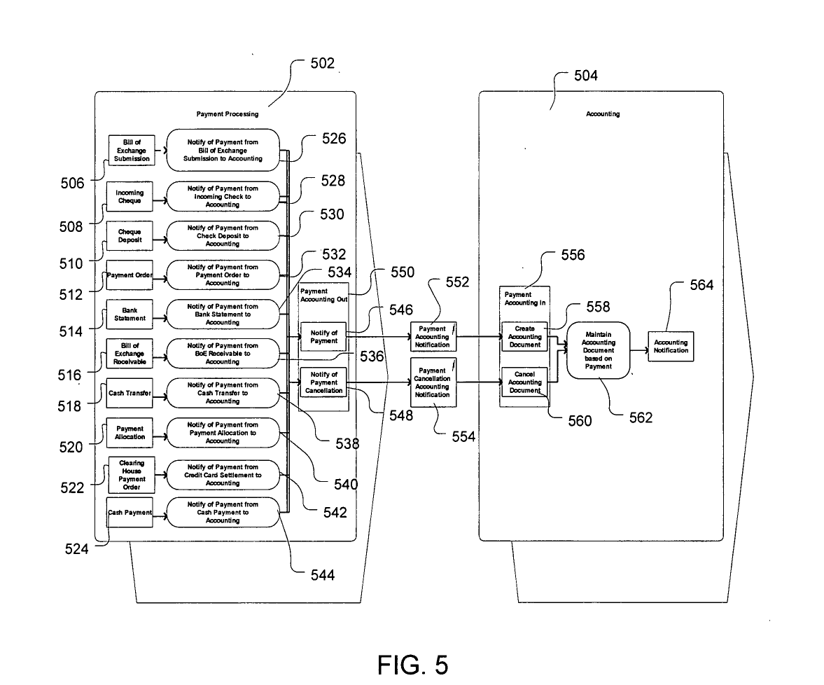

FIG. 5 is a block diagram showing interactions between a Payment Processing process component 504 and an Accounting process component 504 in the architectural design of FIG. 1. The Payment Processing process component 502 includes ten business objects: a Bill of Exchange Submission business object 506, an Incoming Check business object 508, a Check Deposit business object 510, a Payment Order business object 512, a Bank Statement business object 514, a Bill of Exchange Receivable business object 516, a Cash Transfer business object 518, a Payment Allocation business object 520, a Clearing House Payment Order business object 522, and a Cash Payment business object 524

The Bill of Exchange Submission business object 506 sends incoming bill of exchange receivables to the house bank for cashing. The Incoming Check business object 508 represents a check sent by a business partner. The incoming check will be sent to the house bank by a check deposit. The Check Deposit business object 510 sends a collection of incoming checks to the house bank for cashing. The Payment Order business object 512 creates payment media for either a bank, a credit card a settlement institute, or a business partner on the base of payment requests. The Bank Statement business object 514 is a bank statement for a house bank account. The Bill of Exchange Receivable business object 516 represents a Bill of Exchange received from a business partner or a Bill of Exchange Request sent to a business partner. The Cash Transfer business object 518 is a document that shows an internal money transfer between: a bank account and bank account (bank transfer), a cash account and bank account (cash deposit), a bank account and cash account (cash withdrawal), or a cash account and cash account (cash transfer). The Payment Allocation business object 520 documents a process step by which open payments of different types belonging to one another are indicated as confirmed or sent to other components for post processing. For example, an incoming check may confirm a payment advice or a bank statement item may confirm a check deposit. The Clearing House Payment Order business object 522 is an order document for clearing a collection of credit card payments to the clearing house. The Cash Payment business object 524 is a document showing an incoming or outgoing cash payment from or to a business partner.

The Payment Processing process component 502 also includes a number of outbound process agents, each tied to a particular business object. A Notify of Payment from Bill of Exchange Submission to Accounting outbound process agent 526 creates an accounting notification from the Bill of Exchange Submission business object 506. A Notify of Payment from Incoming Check to Accounting outbound process agent 528 may notify the Accounting process component 504 of a bounced or cancelled check. A Notify of Payment from Check Deposit to Accounting outbound process agent 530 may notify the Accounting process component 504 of a change in status of a check deposit. A Notify of Payment from Payment Order to Accounting outbound process agent 532 may notify the Accounting process component 504 of a payment by payment order or a cancellation of payment. A Notify of Payment from Bank Statement to Accounting outbound process agent 534 may notify the Accounting process component 504 of a payment by bank account or a cancellation of payment. A Notify of Payment from Bill of Exchange Receivable to Accounting outbound process agent 536 may notify the Accounting process component 504 of a payment made by a bill of exchange or a cancellation of payment. A Notify of Payment from Cash Transfer to Accounting outbound process component 538 may notify the Accounting process component 504 about a transfer of money between house bank accounts and/or cash accounts or a cancellation of payment. A Notify of Payment from Payment Allocation to Accounting outbound process agent 540 may notify the Accounting process component 504 of a payment made by a payment allocation or a cancellation of payment. A Notify of Payment from Credit Card Settlement to Accounting outbound process agent 542 may notify the Accounting process component 504 of a payment made by credit card or a cancellation of payment. A Notify of Payment from Cash Payment to Accounting outbound process agent 544 may notify the Accounting process component 504 of a payment made by cash or a cancellation of payment.

The outbound process agents above may cause invocation of a Notify of Payment operation 546 or a Request Payment Cancellation operation 548 to update accounting. The operations 546 and 548 may be included in a Payment Accounting Out interface 550. The Payment Accounting Out interface 550 may send a Payment Accounting Notification message 552 or a Payment Accounting Cancellation Request message 554 to a Payment Accounting In interface 556 in the Accounting process component 504. The Payment Accounting In interface 556 includes a Create Accounting Document operation 558 and a Cancel Accounting Document operation 560. A Maintain Accounting Document based on Payment inbound processing component 562 updates the Accounting Notification business object 564. An Accounting Notification is a common input channel for all kinds of operational business transactions into financial accounting that is called by operational components in order to record the business transactions in financial accounting.

Interactions Between Process Components “Due Item Processing” and “Accounting”

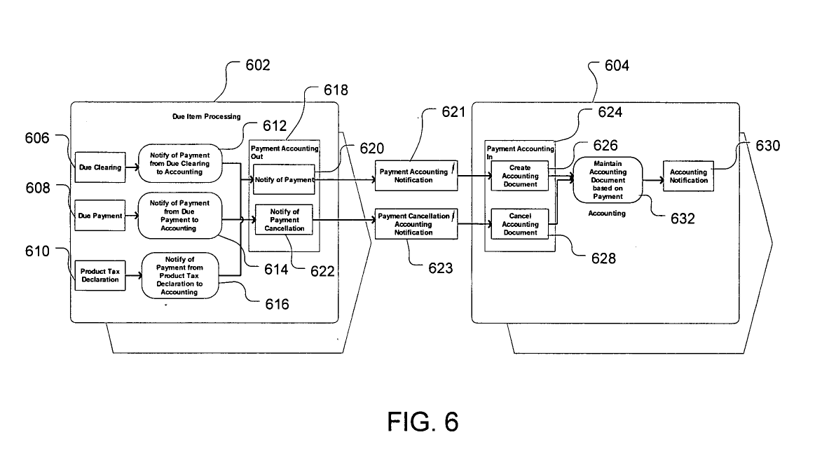

FIG. 6 is a block diagram showing interactions between a Due Item Processing process component 602 and an Accounting process component 604 in the architectural design of FIG. 1. The Due Item Processing process component 602 includes three business objects: a Due Clearing business object 606 to clear the amounts of the receivables and payables of a group balance to zero taking cash discounts and other deductions into account, a Due Payment business object 608 to create payment requests for payment processing, and a Product Tax Declaration business object 610 to declare the product tax liabilities/receivables of a company to the responsible tax authority according to the tax declaration arrangement and country specific legal requirements that triggers the payment to the tax authority.

The business object sends updates into their respective outbound process agents: a Notify of Payment from Due Clearing to Accounting 612, which sends notification for a clearing of trade receivables and/or payables to Accounting, a Notify of Payment from Due Payment to Accounting 614, which sends notification to Accounting for inward or outward trade receivables and/or payables payments, and a Notify of Payment from Product Tax Declaration to Accounting 616, which sends notification for a payment of tax receivables and/or payables to Accounting.

A Payment Accounting Out interface 618 includes a Notify of Payment operation 620, which sends a Payment Accounting Notification message 621 to the Accounting process component 604 notifying Financial Accounting about inward or outward movements of trade or tax receivables or payables. Alternatively, a Request Payment Cancellation operation 622 is invoked that sends a Payment Accounting Cancellation Request message 623 to the Accounting process component 604 cancelling an inward or outward movement of trade or tax receivables or payables in Financial Accounting.

The Accounting process component 604 receives the messages in a Payment Accounting In interface 624, which includes a Create Accounting Document operation 626 to receive Payment Accounting Notification from Payment Processing or Due Item Processing. If the message received was a cancellation, a Cancel Accounting Document operation 628 is invoked which cancels the payment processing or due item processing. Updates are sent to the Accounting Notification business object 630 using a Maintain Accounting Document based on Payment inbound process agent 632. An Accounting Notification business object 630 is a common input channel for all kinds of operational business transactions into financial accounting that is called by operational components in order to record the business transactions in financial accounting.

Interactions Between Process Components “Customer Invoice Processing” and “Supplier Invoice Processing at Customer”

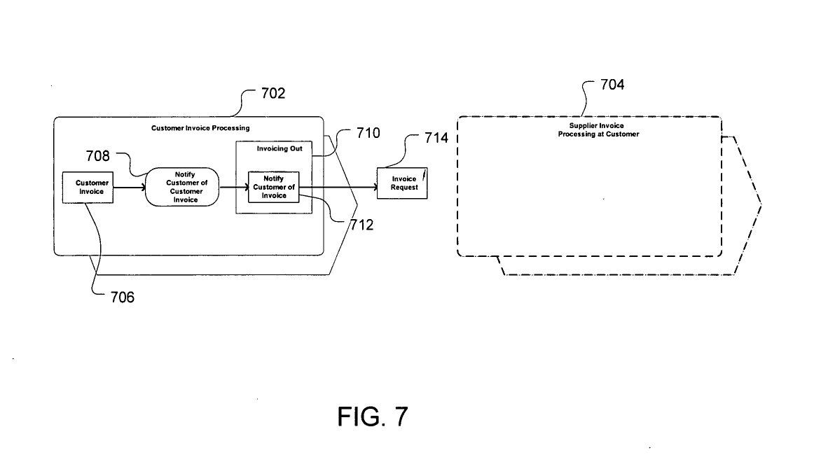

FIG. 7 is a block diagram showing interactions between a Customer Invoice Processing process component 702 and a Supplier Invoice Processing at Customer process component 704 in the architectural design of FIG. 1. The Customer Invoice Processing process component 702 includes a Customer Invoice business object 706, a Notify Customer of Customer Invoice inbound process agent 708, and a Notify Customer of Invoice operation in an Invoicing Out interface 710. The Customer Invoice business object 706 is an object used to charge a customer for delivery of goods or services.

The Customer Invoice business object 706 initiates a Notify Customer of Invoice operation 712 in the Notify Customer of Invoice operation in an Invoicing Out interface 710 to fill billing document with data for customer usage. Upon completion of the operation, the Notify of Customer Invoice operation 712 transmits an Invoice Request message 714 requesting that the update be made.

Process Component Interaction Model “Logistics Execution Control” and “Outbound Delivery Processing”

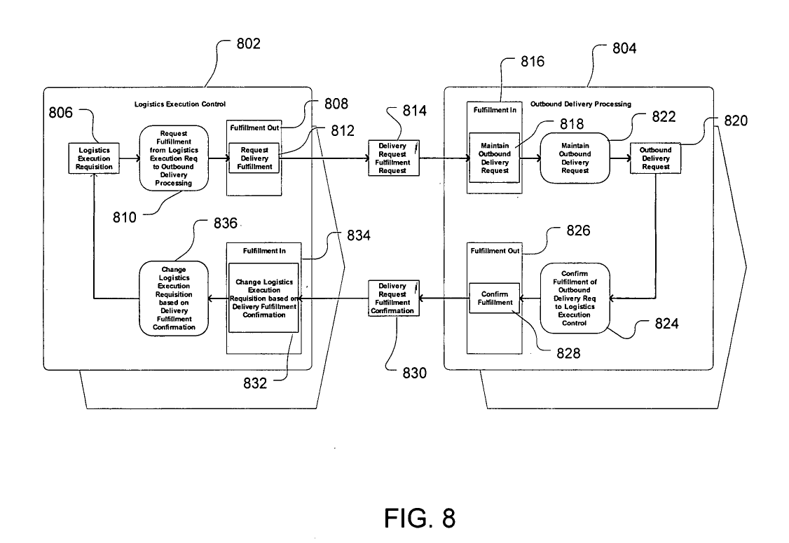

FIG. 8 is a block diagram showing interactions between a Logistics Execution Control process component 802 and an Outbound Delivery Processing process component 804 in the architectural design of FIG. 1. The Logistics Execution Control process component 802 controls and monitors, on a macro logistics level, the supply chain execution activities necessary for the fulfillment of an order. It sends information to Logistics Execution to trigger the necessary supply chain execution activities, receives information about the supply chain execution progress, and updates data relevant for both fulfillment and supply and demand planning.

The Logistics Execution Control process component 802 includes a Logistics Execution Requisition business object 806 that sends data into a Fulfillment Out interface 808 using a Request Fulfillment from Logistics Execution Request to Outbound Delivery Processing outbound process agent 810. The Fulfillment Out interface 808 includes a Request Delivery Fulfillment operation 812 performed to maintain a delivery request The Logistics Execution Requisition business object 806 may send instructions to Logistics Execution, which supports the controlling, triggering and monitoring of supply chain execution activities necessary for the fulfillment of an order. A Delivery Fulfillment Request message 814 is then transmitted to a Fulfillment In interface 816 located in the Outbound Delivery Processing process component 804. The interface contains a Maintain Outbound Delivery Request operation 818, which receives delivery fulfillment requests from Logistics Execution Control and sends the requests into an Outbound Delivery Request business object 820 using a Maintain Outbound Delivery Request inbound delivery process agent 822. The Outbound Delivery Request business object 820 is a document in the inbound delivery process containing all the relevant logistics data from the initiator of the inbound delivery process, such as the purchase order. The inbound delivery request is used to validate an inbound delivery and an advanced shipping notification, and to prepare inbound logistics for receiving the goods. Upon receipt of the inbound delivery request, a Confirm Fulfillment of Outbound Delivery Request to Logistics Execution Control outbound delivery agent 824 sends the confirmation data into a Fulfillment Out interface 826 where a Confirm Fulfillment operation 828 may take place. Upon completion of the Confirm Fulfillment operation 828, a Delivery Fulfillment Confirmation message 830 is created and transmitted back to the Logistics Execution Control process component 802 to receive fulfillment confirmation data. Receiving the Delivery Fulfillment Confirmation message 830 in the Logistics Execution Control process component 802 may invoke a Change Logistics Execution Requisition based on the Delivery Fulfillment Confirmation operation 832. The operation 832 is part of a Fulfillment In interface 834. The operation 832 may then send updates or changes by way of a Change Logistics Execution Requisition based on Delivery Fulfillment inbound process agent 836 into the Logistics Execution Requisition business object 806.

Interactions Between Process Components “Outbound Delivery Processing” and “Customer Invoice Processing”

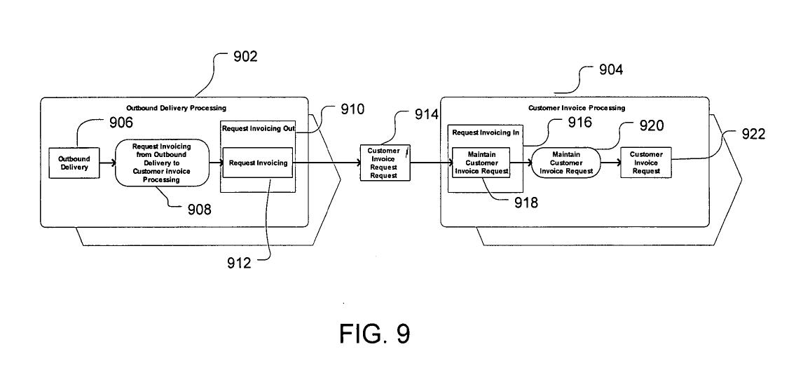

FIG. 9 is a block diagram showing interactions between an Outbound Delivery Processing process component 902 and a Customer Invoice Processing process component 904 in the architectural design of FIG. 1. The Outbound Delivery Processing process component 902 includes an Outbound Delivery business object 906. The Outbound Delivery business object 906 is a document containing the delivery note, which additionally records the goods that have actually been received by the goods recipient.

A Request Invoicing from Outbound Delivery to Customer Invoice Processing outbound process agent 908 sends information to a Request Invoicing Out interface 910, which includes a Request Invoicing operation 912 that sends a billing due notification to Customer Invoice Processing. Next, a Customer Invoice Request message 914 is generated and transmitted to the Customer Invoice Processing process component 904.

Upon receiving the message 914, a Request Invoicing In interface 916 includes a Maintain Customer Invoice operation 918 to create, update, delete or request cancellation of a customer invoice request. A Maintain Customer Invoice Request inbound process agent 920 updates a Customer Invoice Request business object 922.

Interactions Between Process Components “Sales Order Processing” and “Customer Invoice Processing”

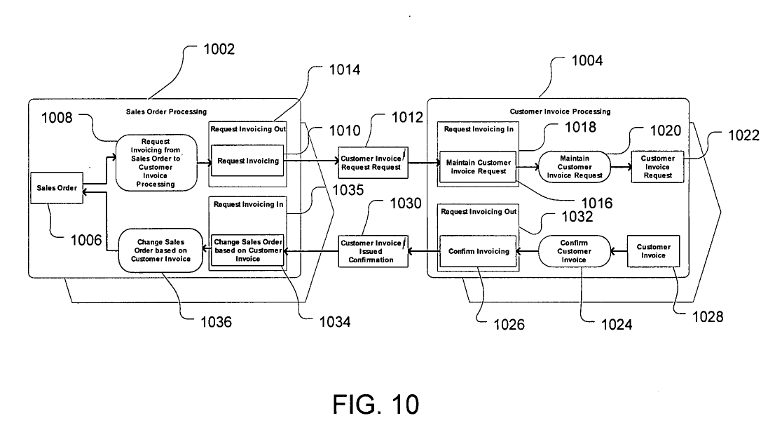

FIG. 10 is a block diagram showing interactions between a Sales Order Processing process component 1002 and a Customer Invoice Processing process component 1004 in the architectural design of FIG. 1. The Sales Order Processing process component 1002 includes a Sales Order business object 1006. The Sales Order business object 1006 is a customer request to the company for delivery of goods or services at a certain time.

In the Sales Order Processing process component 1002, a Request Invoicing from Sales Order to Customer Invoice Processing outbound process agent 1008 requests the execution of a service request. The outbound process agent 1008 uses a Request Invoicing operation 1010 to send a Customer Invoice Request Request message 1012 to the Customer Invoice Processing process component. The Request Invoicing operation 1010 is part of a Request Invoicing Out interface 1014.

The Customer Invoice Request Request message 1012 is received by a Maintain Customer Invoice Request operation 1016, which creates, updates, deletes or requests cancellation of customer invoice requests in a Request Invoicing In interface 1018. The operation 1016 initiates a Maintain Customer Invoice Request inbound process agent 1020. The Customer Invoice Processing process component 1004 includes a Customer Invoice Request business object 1022. The Customer Invoice Request business object 1022 is used to charge a customer for delivery of goods or services.

In the Customer Invoice Processing process component 1004, a Confirm Customer Invoice outbound process agent 1024 requests the execution of a Confirm Invoicing operation 1026 that confirms that a Customer Invoice business object 1028 was created (or cancelled) to process components, which requested the invoicing. The outbound process agent 1024 uses the Confirm Invoicing operation 1026 to send a Customer Invoice Issued Confirmation message 1030 to the Sales Order Processing process component 1002. The Confirm Invoicing operation 1026 is part of a Request Invoicing Out interface 1032.

The Customer Invoice Issued Confirmation message 1030 is received by a Change Sales Order based on Customer Invoice operation 1034 in a Request Invoicing In interface 1035. The operation 1034 updates sales orders with information from customer invoices using a Change Sales Order based on Customer Invoice inbound process agent 1036. The inbound process agent 1036 updates the Sales Order business object 1006.

Interactions Between Process Components “Payment Processing” and “Payment Processing at Business Partner”

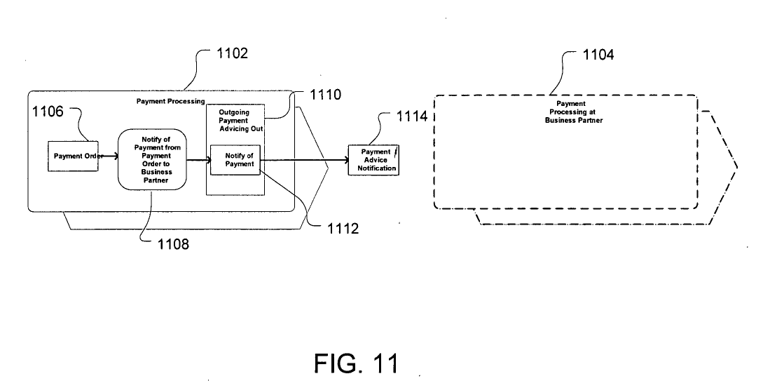

FIG. 11 is a block diagram showing interactions between a Payment Processing process component 1102 and a Processing at Business Partner process component 1104 in the architectural design of FIG. 1. The Payment Processing process component 1102 is used to handle all incoming and outgoing payments and to represent the main database for a liquidity status. Business partners may be any third party operating an independent system.

The interaction model begins in the Payment Processing process component 1102 with a Payment Order business object 1106. The Payment Order business object 1106 creates payment media for either a bank, a credit card a settlement institute, or a business partner on the base of payment requests. After the payment is created, the Payment Order business object 1106 sends a notification using a Notify of Payment from the Payment Order to the Business Partner outbound process agent 1108. A Payment Order can create different (sub) items within a payment, one for each check, bank transfer etc. that is sent if the payment medium is subject to amount limitations. The Payment Processing process component 1102 also contains an outgoing payment Advicing Out interface 1110 that includes a Notify of Payment operation 1112. The Notify of Payment operation creates a payment advice and sends a Payment Advice Notification message 1114 to the Payment Processing at Business Partner processing component 1104.

Interactions Between Process Components “Customer Invoice Processing” and “Accounting”

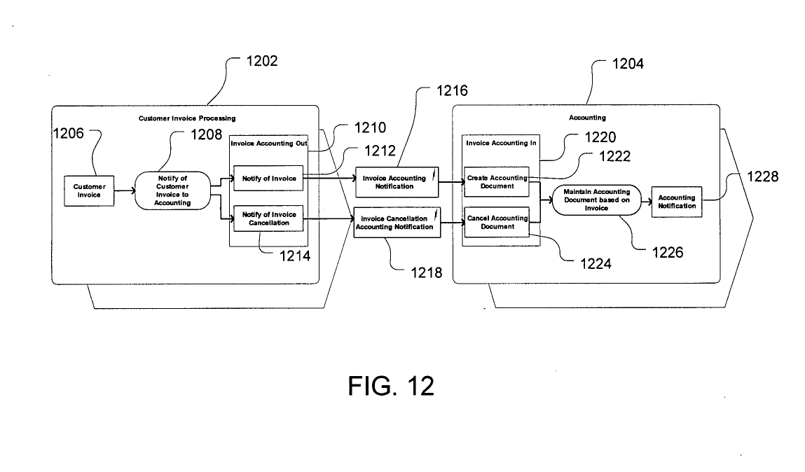

FIG. 12 is a block diagram showing interactions between a Customer Invoice Processing process component 1202 and an Accounting process component 1204 in the architectural design of FIG. 1. The Customer Invoice Processing process component 1202 includes a Customer Invoice business object 1206. The Customer Invoice business object 1206 is used to charge a customer for delivery of goods or services. The customer invoice is then sent into a Notify of Customer Invoice to Accounting outbound process agent 1208, which notifies accounting of the existence of the customer invoice.

The processing agent provides an Invoice Accounting Out interface 1210 with the notification and additional data such as invoice billing numbers or a credit memo. Here, the interface 1210 includes a Notify of Invoice operation 1212 and a Notify of Invoice Cancellation operation 1214. The Notify of Invoice operation 1212 may be invoked if the invoice accounting out interface receives a notification to post an invoice. Upon performing the Notify of Invoice operation 1212, the outbound process agent transmits an Invoice Accounting Notification message 1216 with the invoice accounting notification. Alternatively, the Notify of Invoice Cancellation operation 1214 may be invoked if the Invoice Accounting Out interface 1210 receives information requesting a cancellation. For example, the Notify of Invoice Cancellation operation 1214 may be invoked in order to cancel an invoice. Upon performing the Notify of Invoice Cancellation operation 1214, the Notify of Customer Invoice Accounting outbound process agent transmits an Invoice Cancellation Accounting message 1218 with the invoice accounting cancellation request.

The Accounting process component 1204 may receive messages 1216, 1218 sent by the Customer Invoice Processing process component 1204. Here, an Invoice Accounting interface 1220 includes a Create Accounting Document operation 1222 that creates an accounting document for a customer invoice or supplier invoice if accounting receives the Invoice Accounting Notification message 1216. The Invoice Accounting interface 1220 also includes a Cancel Accounting Document operation 1224 that cancels a customer or supplier invoice.

The Accounting process component 1204 includes a Maintain Accounting Document based on Invoice inbound process agent 1226 that can maintain accounting documents. For example, the inbound process agent 1226 may update the accounting document if a creation or cancellation operation is received. After updating the accounting document, the inbound process agent 1226 may forward information about the updated document into the Accounting Notification business object 1228. The Accounting Notification business object 1228 may receive input from operational business transactions, such as the invoice notification above, and record the business transactions in the Financial Accounting deployment unit.

Interactions Between Process Components “Payment Processing” and “Payment Order Processing at House Bank”

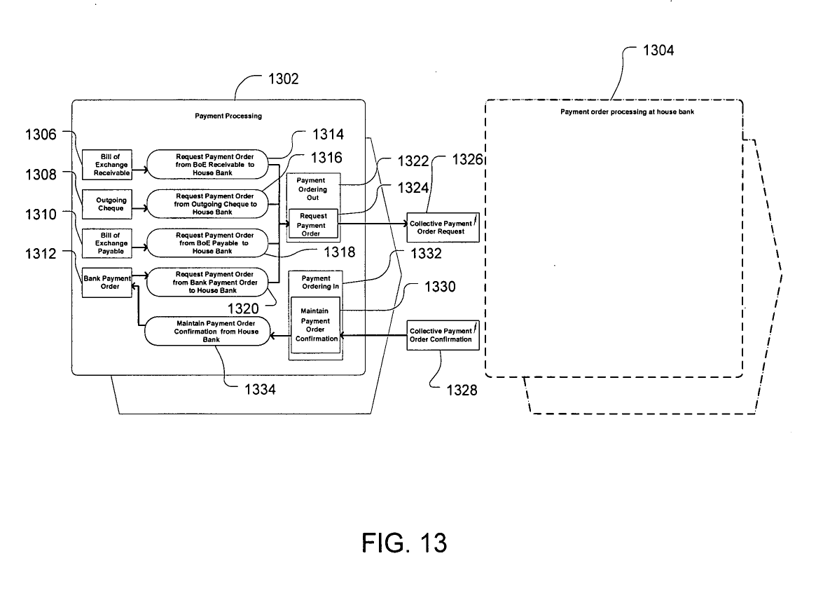

FIG. 13 is a block diagram showing interactions between a Payment Processing process component 1302 and a Payment Order processing at house bank process component 1304 in the architectural design of FIG. 1. The Payment Processing process component 1302 includes four business objects: a Bill of Exchange Receivable business object 1306 that represents a Bill of Exchange received from or a Bill of Exchange Request sent to a business partner, an Outgoing Check business object 1308 that represents a check sent to a business partner that is created via payment order, a Bill of Exchange Payable business object 1310 that represents a Bill of Exchange sent to a business partner that is created only via payment order, and a Bank Payment Order business object 1312 which is a Payment Order that will be sent to a house bank and may contain bank transfers as well direct debits.

Various process agents are used to send updates for each of these business objects. The Request Payment Order from Bill of Exchange Receivable to House Bank outbound process agent 1314 creates an electronic Bill of Exchange Receivable (Request). The Request Payment Order from Outgoing Check to House Bank 1316 creates an outgoing check to be printed externally. The Request Payment Order from Bill of Exchange Payable to House Bank outbound process agent 1318 creates an electronic Bill of Exchange Payable. The Request Payment Order from Bank Payment Order to House Bank outbound process agent 1320 creates a Payment order to House Bank.

The Payment Ordering Out interface 1322 receives the updates from the outbound process agents 1314, 1316, 1318, and 1320. A Request Payment Order operation 1324 collects Bank Transfers or Direct Debits for payment submission to the business partner. A Collective Payment Order Request message 1326 is generated and processed by the Payment order processing at house bank process component 1304. Upon completion of processing, a Collective Payment Order Confirmation message 1328 is sent to the Payment Ordering In interface 1330 that includes a Maintain Payment Order Confirmation operation 1332 to confirm the status updates from processing a payment order. After completing the operation 1332, an update is sent to the Bank Payment Order business object 1312 using the Maintain Payment Order Confirmation from House Bank inbound process agent 1334.

Interactions Between Process Components “Sales Order Processing” and “Accounting”

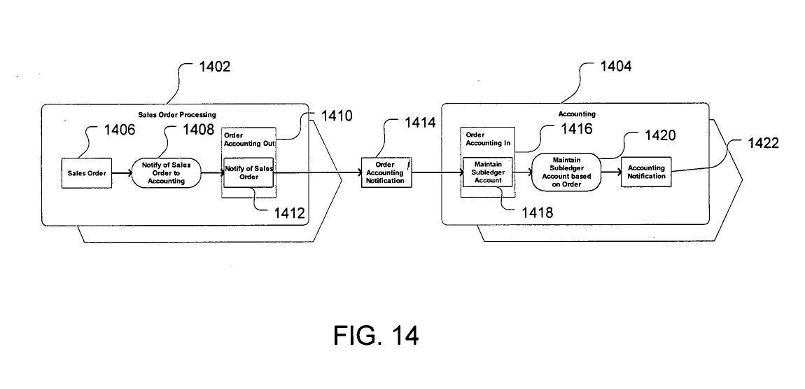

FIG. 14 is a block diagram showing interactions between a Sales Order Processing process component 1402 and an Accounting process component 1404 in the architectural design of FIG. 1. The Sales Order Process component 1402 includes the Sales Order business object 1406, which passes information into a Notify of Sales Order to Accounting outbound process agent 1408. The information may contain notifications about created, changed or cancelled sales orders.

The outbound process agent 1408 sends notification into an Order Accounting Out interface 1410 which includes a Notify of Sales Order operation 1412. The Notify of Sales Order operation 1412 notifies Accounting about the creation, change or cancellation of a sales order. An Order Accounting Notification message 1414 may then be sent to the Accounting process component 1404.

The Accounting process component 1404 receives the Order Accounting Notification message 1414 in the interface 1416 which includes a Maintain Subledger Account operation 1418 that receives order accounting notifications from the Purchase Order Processing process component 1402. The notification is to inform Accounting Processing about the creation, the change or the deletion of any kind of order business objects. The notification may then be sent to the Accounting Notification business object 1422 using an inbound process agent 1420. The Accounting Notification business object 1422 is a common input channel for all kinds of operational business transactions into Financial Accounting that is called by operational components in order to record the business transactions in Financial Accounting.

Interactions Between Process Components “Payment Processing” and “Due Item Processing”

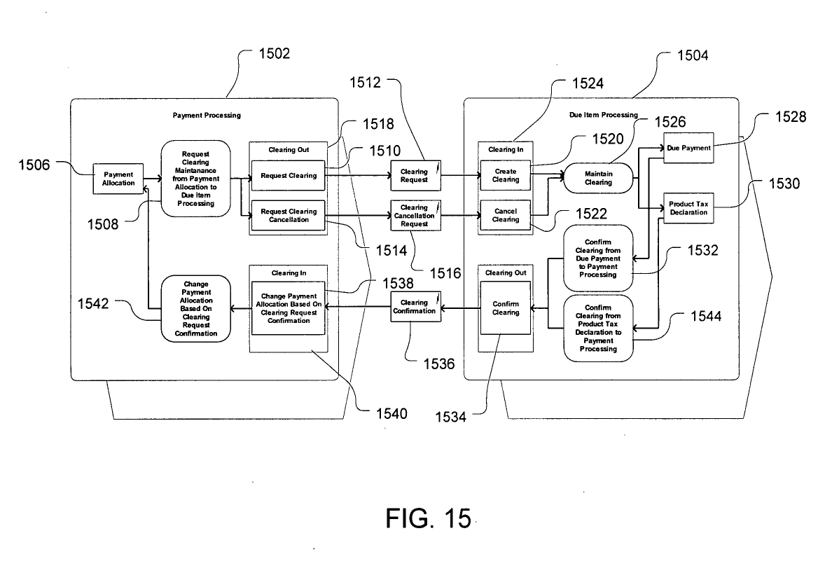

FIG. 15 is a block diagram showing interactions between a Payment Processing process component 1502 and a Due Item Processing process component 1504 in the architectural design of FIG. 1.

The Payment Processing process component 1502 includes a Payment Allocation business object 1506. The Payment Allocation business object 1506 documents a process step by which open payments of different type belonging to one another are indicated as confirmed or sent to other components for post processing. In the Payment Processing process component 1502, a Request Clearing Maintenance from Payment Allocation to Due Item Processing outbound process agent 1508 uses a Request Clearing operation 1510 to send a Clearing Request message 1512 to request the clearing of payments within the Due Item Processing process component 1504. Alternatively, the outbound process agent 1508 may invoke a Request Clearing Cancellation operation 1514 to cancel a payment clearing using a Clearing Cancellation Request message 1516. Both operations are part of a Clearing Out interface 1518 in the Payment Processing process component 1502.

The messages 1512, 1516 are received in the Due Item Processing process component 1504 in a Create Clearing operation 1520 and a Cancel Clearing operation 1522, respectively. The Create Clearing operation 1520 and the Cancel Clearing operation 1522 are both part of a Clearing In interface 1524. Upon creating or canceling clearing, a Maintain Clearing inbound process agent 1526 may update a Due Payment business object 1528 or a Product Tax Declaration business object 1530, or both.

The Due Payment business object 1528 creates payment requests for payment processing. A Confirm Clearing from Due Payment to Payment Processing outbound process agent 1532 may invoke a Confirm Clearing operation 1534 that sends a Clearing Confirmation message 1536 to payment processing for a clearing request. The message 1536 is received by a Change Payment Allocation based On Clearing request Confirmation operation 1538 that confirms the execution or rejection of a sent Clearing Request. The operation is part of a Clearing In interface 1540. An update may be sent to the Payment Allocation business object 1506 using a Change Payment Allocation Based on Clearing Request Confirmation inbound process agent 1542.

The Product Tax Declaration business object 1530 is a declaration of the product tax liabilities/receivables of a company to the responsible tax authority according to the tax declaration arrangement and country specific legal requirements that triggers the payment to the tax authority. The Product Tax Declaration business object 1530 may invoke the same sequence of events, using a Confirm Clearing from Product Tax Declaration to Payment Processing outbound process agent 1544 instead of the outbound process agent 1532, that the Due Payment business object above has completed.

Interactions Between Process Components “Logistics Execution Control” and “Site Logistics Processing”

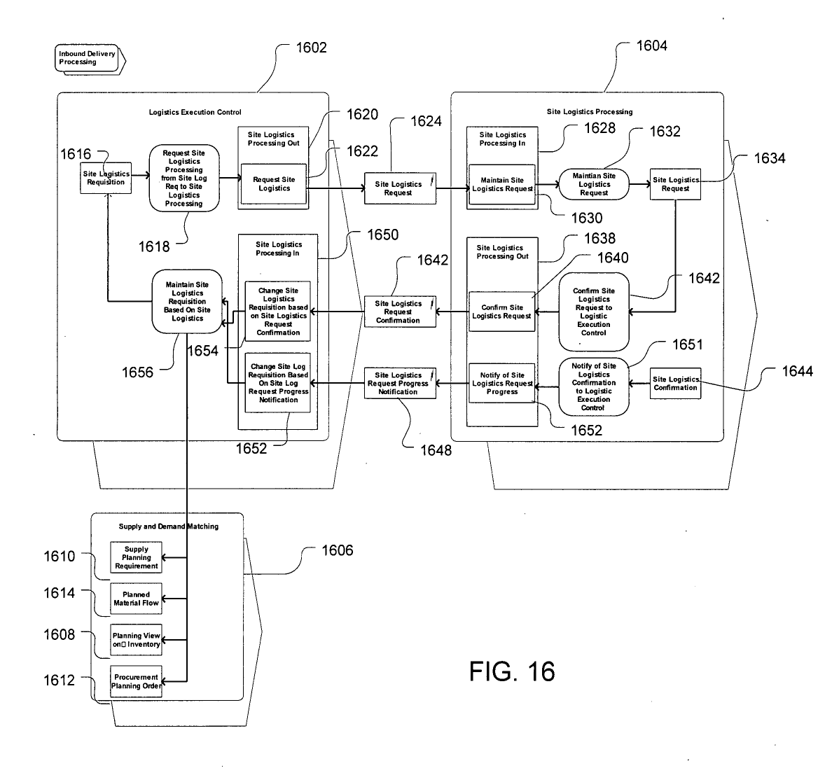

FIG. 16 is a block diagram showing interactions between a Logistics Execution Control process component 1602, a Site Logistics process component 1604, and a Supply and Demand Matching process component 1606 in the architectural design of FIG. 1.

Four business objects from the Supply and Demand Matching process component 1606 are used in the Logistics Execution Control process component 1602: a Planning View on Inventory 1608, which is a planning view on Inventory is an object that represents the inventory object from logistics execution, a Supply Planning Requirement 1610, which is a requirement object that is used as the target for the supply planning run and the availability check, a Procurement Planning Order 1612, which defines the requested or expected material receipt in a specific quantity and at a specific availability date, and a Planned Material Flow 1614, which is an object that defines the relationship between material receipt elements and material requirements elements of a material within a location.

The Logistics Execution Control process component 1602 includes a Site Logistics Requisition business object 1616 that uses a Request Site Logistics Processing from Site Log Request to Site Logistics Processing outbound process agent 1618 to send an update to the Request Site Logistics process component 1604.

The Site Logistics Processing Out interface 1620 includes a Request Site Logistics operation 1622 to send a request in order to maintain the site logistics request. The Site Logistics Request message 1624 may then be generated and sent to the Site Logistics process component 1604.

The Site Logistics Processing In interface 1628 includes a Maintain Site Logistics Request operation 1630 that creates or updates a Site Logistics Processing Request. A Maintain Site Logistics Request in bound process agent 1632 may send an update into a Site Logistics Request business object 1634. The Site Logistics Request business object 1634 performs Site Logistics operations supporting outbound, inbound and site internal logistics activities at a certain time. A Confirm Site Logistics Request to Logistic Execution Control outbound process agent 1636 may send updated information into a Sit Logistics Processing Out interface 1638 which includes a Confirm Site Logistics Request operation 1640 that confirms receipt of request and acknowledges quantities and delivery dates. This operation 1640 generates a Site Logistics Request Confirmation message 1642 which will be sent to update the Logistics Execution Control process component 1602.

A Site Logistics Confirmation business object 1644 may also send updated information into the Logistics Execution Control process component 1602. The Site Logistics Confirmation business object is a document that collects actual data posted with reference to a site logistics order or site logistics request. The site logistics confirmation updates inventory, finance and planning. A Notify of Site Logistics Confirmation to Logistic Execution Control outbound process agent 1651 invokes a Notify of Site Logistics Request Progress operation 1646 that informs logistics execution control about inventory changes and fulfillment of Site Logistics Processing. A Site Logistics Request Progress Notification message 1648 may be generated to update the Logistics Execution Control process component 1602.

Upon receiving messages 1640 and 1642, the Logistics Execution Control process component 1602 may perform the following operations: 1. The Site Logistics Processing In interface 1650 includes a Change Site Log. Requisition Based On Site Logistic Request Progress Notification operation 1652, which notifies Logistics execution control of inventory changes and confirmation of Site Logistics Processing. The Site Logistics Processing In interface 1650 also includes a Change Site Logistics Requisition based on Site Logistics Request Confirmation operation 1654 that receives confirmation data from Site Logistics Request. A Maintain Site Logistics Requisition Based on Site Logistics inbound process agent 1656 may then update the Site Logistics Requisition business object 1616.

Interactions Between Process Components “Sales Order Processing” and “Customer Requirement Processing”

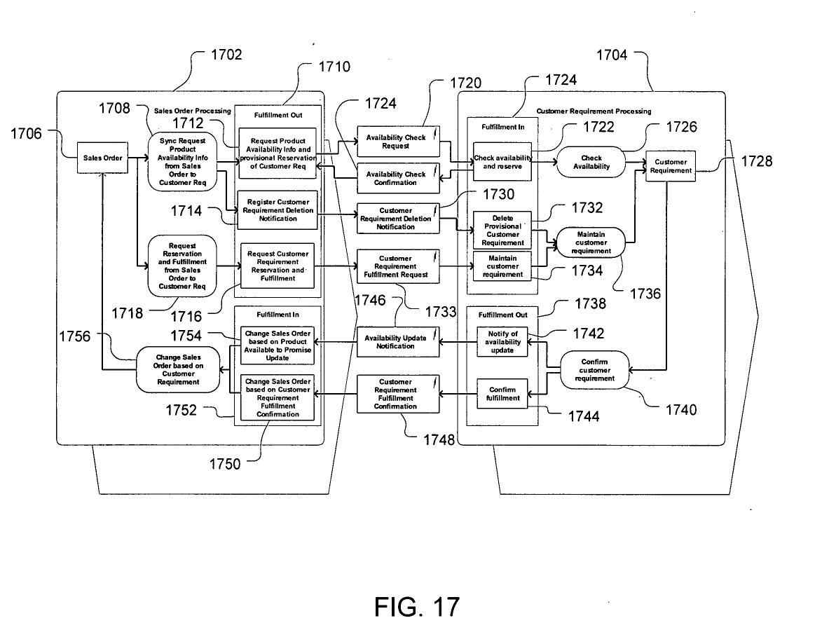

FIG. 17 is a block diagram showing interactions between a Sales Order Processing process component 1702 and a Customer Requirement Processing process component 1704 in the architectural design of FIG. 1.

The Sales Order Processing process component 1702 includes a Sales business object 1706. The Sales Order business object 1706 uses a Synchronous Request Availability Information from Sales Order to Customer Requirements process agent 1708 to send update information into a Fulfillment Out interface 1710.

The Fulfillment Out interface 1710 may invoke one or more of three operations depending on the received data instructions: a synchronous Request Product Availability Information and provisional Reservation of Customer Requisition operation 1712 to request availability information for sales order items, a Register Customer Requirement Deletion Notification operation 1714 to register provisional requirement reservations for deletion and triggers deletion in case of failure or cancellation of transaction processing, or a Request Customer Requirement Reservation and Fulfillment operation 1716 that requests reservation and fulfillment for customer requirements. The last operation 1716 is invoked by a Request Reservation and Fulfillment from Sales Order to Customer Requirement outbound process agent 1718.

If the Request Product Availability Information and provisional Reservation operation 1712 is invoked, then an Availability Check Request message 1720 may be transmitted to the Customer Requirement Processing process component 1704 where it is received in a synchronous Check Availability and Reserve operation 1722. An Availability Check Confirmation message 1724 is transmitted back to the Sales Order Processing process component 1704 to confirm the receipt of the request. Next, a Check Availability outbound process agent 1726 updates the Customer Requirement business object 1728.

If the Register Customer Requirement Deletion Notification operation 1714 is invoked, a Customer Requirement Deletion Notification message 1730 is sent to the Customer Requirement Processing process component 1704 where it is received in a Delete Provisional Customer Requirement operation 1732. The Request Customer Requirement Reservation and Fulfillment operation 1716 may also be invoked to send a Customer Requirement Fulfillment Request message 1733. The message 1733 is received in a Maintain Customer Requirement operation 1734 that creates or changes a customer requirement. Next, a Maintain Customer Requirement inbound process agent 1736 may update the Customer Requirement business object 1728 about the request, deletion or fulfillment of the sales order.

Upon receiving the update, the Customer Requirement business object 1728 sends the update to a Fulfillment Out interface 1738 using a Confirm Customer Requirement outbound process agent 1740. The Fulfillment Out interface invokes a Notify of Availability update operation 1742 that notifies the creator of a customer requirement about an updated availability situation for the products requested within the customer requirement using an Availability Update Notification message 1746. Alternatively, a Confirm Fulfillment operation 1744 may be invoked that generates a Customer Requirement Fulfillment Confirmation message 1748. Both messages may be received in a Fulfillment In interface 1750 on the Sales Order Processing process component 1702.

If the Availability Update Notification is received, a Change Sales Order based on Availability Update operation 1754 is invoked. Otherwise, the Customer Requirement Fulfillment Confirmation message 1748 will be received and a Change Sales Order based on Fulfillment Confirmation operation 1752 will be invoked. A Change Sales Order based on Customer Requirement inbound process agent 1756 may then update the Sales Order business object 1706.

Interactions Between Process Components “Outbound Delivery Processing” and “Inbound Delivery Processing at Customer”

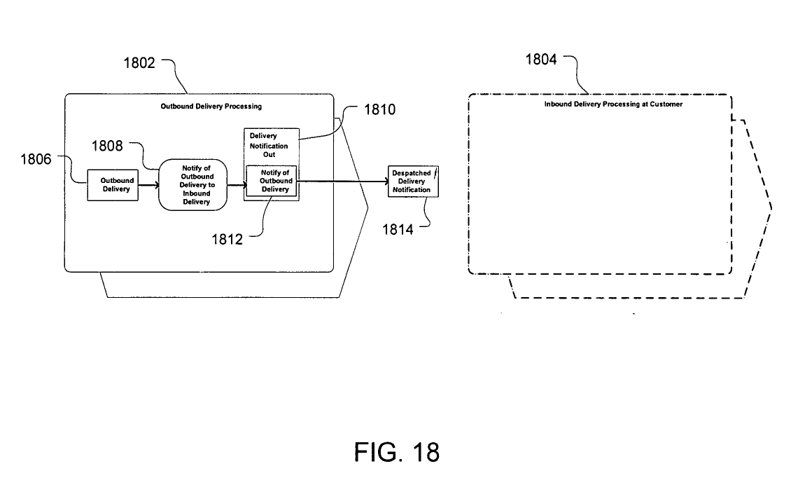

FIG. 18 is a block diagram showing interactions between an Outbound Delivery Processing process component 1802 and an Inbound Delivery Processing at Customer process component 1804 in the architectural design of FIG. 1. The Outbound Delivery Processing process component 1802 includes an Outbound Delivery business object 1806. The Outbound Delivery business object 1806 is a document containing the delivery note, which additionally records the goods that have actually been received by the goods recipient.

A Notify of Outbound Delivery to Inbound Delivery outbound process agent 1808 sends information to a Delivery Notification Out interface 1810, which includes a Notify of Outbound Delivery operation 1812 that sends a dispatched delivery notification to an Inbound Delivery Processing at Customer process component 1804. A Dispatched Delivery Notification message 1814 is then generated and transmitted to the Inbound Delivery Processing at Customer process component 1804.

Interactions Between Process Components “Site Logistics Processing” and “Accounting”

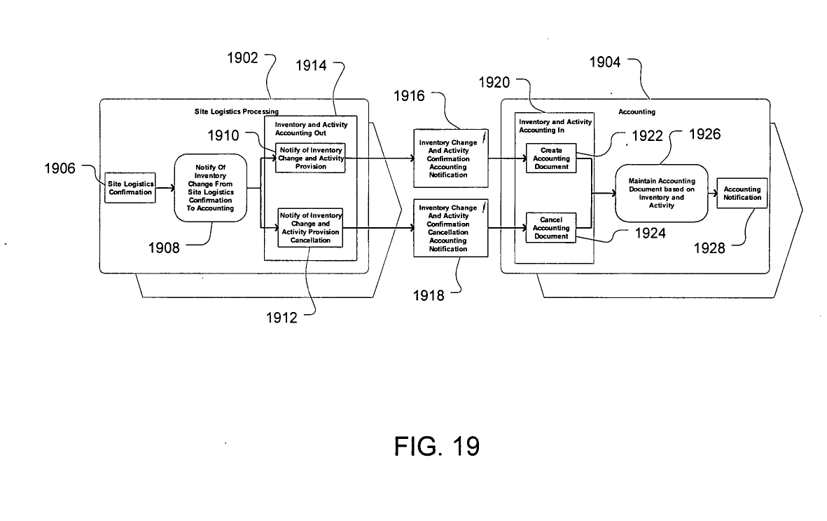

FIG. 19 is a block diagram showing interactions between a Site Logistics Processing process component 1902 and an Accounting process component 1904 in the architectural design of FIG. 1. The Site Logistics Processing process component 1902 includes a Site Logistics Confirmation business object 1906, which is a document that collects actual data posted with reference to a site logistics order or site logistics request. The site logistics confirmation updates inventory, finance and planning.

The Notify of Inventory Change From Site Logistics Confirmation to Accounting outbound process agent 1908 uses a Notify of Inventory Change and Activity Provision operation 1910 to send an Inventory Change Accounting Notification to Accounting Notification message 1916. Alternatively, a Notify of Inventory Change and Activity Provision Cancellation operation 1912 may be invoked to request inventory change and activity provision cancellation. Both operations may be used in an Inventory and Activity Accounting Out interface 1914. If the Notify of Inventory Change and Activity Provision operation 1910 is invoked, then the Inventory Change and Activity Confirmation Accounting Notification message 1916 is sent to the Accounting process component 1904. If the Request Inventory Change and Activity Provision Cancellation operation 1912 is invoked, the Inventory Change and Activity Confirmation Accounting Cancellation Request message 1918 is sent to the Accounting process component 1904.

The messages 1916 and 1918 are received by an Inventory and activity Accounting In interface 1920 where operations may be performed. If a notification message 1916 is received, then a Create Accounting Document operation 1922 is performed to Receive Inventory Change Accounting Notification from Confirmation and Inventory or Site Logistics Processing or Production. If a cancellation message 1918 is received, then a Cancel Accounting Document operation 1924 is performed to Receive Inventory Change Accounting Cancellation Request from Confirmation and Inventory or Site Logistics Processing or Production. Cancellations and updates may be sent by a Maintain Accounting Document based on Inventory and Activity inbound process agent 1926 to an Accounting Notification business object 1928.

Interactions between Process Components “Customer Quote Processing” and “Customer Requirement Processing”

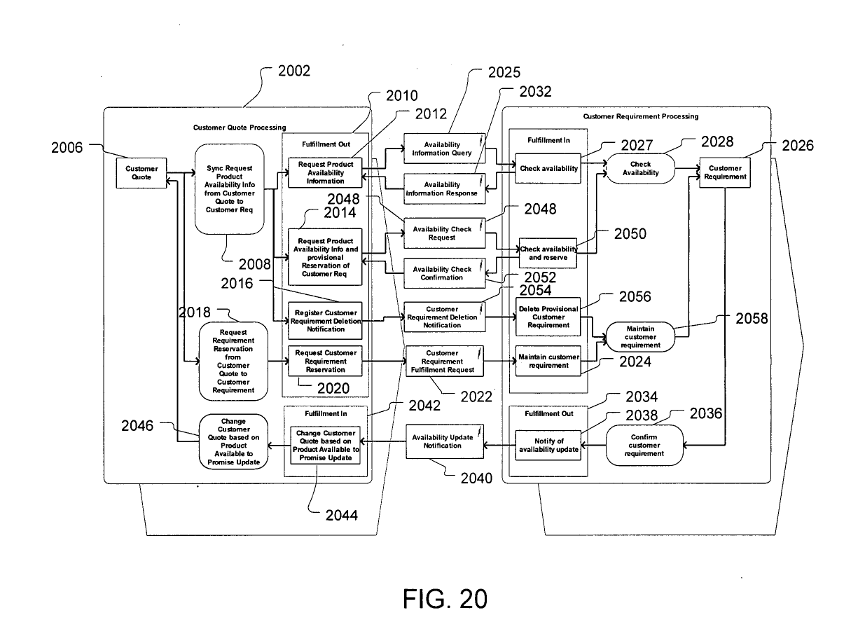

FIG. 20 is a block diagram showing interactions between a Customer Quote Processing process component 2002 and a Customer Requirement Processing process component 2004 in the architectural design of FIG. 1.

The Customer Quote Processing process component 2002 component includes a Customer Quote business object 2006. The Customer Quote business object 2006 is a document containing an offer by a vendor to a customer for the delivery of goods or services according to fixed terms. The offer is legally binding for a specific period of time. The Customer Quote business object 2006 uses a Synchronous Request Availability Information from Customer Quote to Customer Requirements process agent 2008 to send update information into a Fulfillment Out interface 2010.

The Fulfillment Out interface 2010 may invoke one or more of three operations depending on the received data instructions. A synchronous Request Product Availability Information operation 2012 may be invoked to request availability information for customer quote items. A Request Product Availability Information and provisional Reservation operation 2014 may be invoked that requests availability information, including the creation of a provisional reservation for customer quote items. Lastly, a Register Customer Requirement Deletion Notification operation 2016 may be invoked that registers provisional requirement reservations for deletion and triggers deletion in case of failure or cancellation of transaction processing.

In addition, a second outbound process agent 2018 (Request Reservation from Customer Quote to Customer Requirement) may send update information to the Fulfillment Out interface 2010, which may invoke a Request Customer Requirement Reservation operation 2020 that requests fulfillment planning for customer quote items. A Customer Requirement Fulfillment Request message 2022 may be sent to a Maintain Customer Requirement operation 2024 in the Customer Requirement Processing process component 2004.

If the Request Product Availability Information operation 2012 is performed, then an Availability Information Query message 2025 is generated and sent to the Customer Requirement Processing process component 2004 where the update received in a synchronous Check Availability operation 2027 and sent on to a Customer Requirement business object 2026 using a Check Availability outbound process agent 2028. The Customer Requirement business object 2026 is a requirement document that is derived from a sales order or quotation and to which details on the anticipated availability date are added. It may contain the quantities of products required at specific dates as well as information about which products will be available or delivered in which quantities at which dates. In addition to forwarding information to the Customer Requirement business object 2026, the Check availability operation 2030 may send an Availability Information Response Message 2032 back to the Customer Quote Processing process component.

Upon receiving the update, the Customer Requirement business object 2026 is sent to a Fulfillment Out interface 2034 using a Confirm Customer Requirement outbound process agent 2036. The Fulfillment Out interface 2034 invokes a Notify of Availability update operation 2038 that notifies the creator of a customer requirement about an updated availability situation for the products requested within the customer requirement. An Availability Update Notification message 2040 is generated and sent into a Fulfillment In interface 2042 in the Customer Quote Processing process agent 2002.

The Fulfillment In Interface 2042 may invoke a Change Customer Quote based on Availability Update operation 2044 that changes customer quote with availability and reservation information based on changes in fulfillment planning. An inbound process agent 2046 (Change Customer Quote based on Availability Update) may send update information to the Customer Quote business object 2006.

If the synchronous Request Product Availability Information and Provisional Reservation operation 2014 is performed, an Availability Check Request message 2048 may be generated and sent to a synchronous Check availability and Reserve operation 2050 that checks the availability of specific amounts of certain materials and confirms this availability to the caller in the Customer Requirement Processing process component 2004. The message 2048 may be sent on to the Customer Requirement and an Availability Check Confirmation message 2052 may be sent back to the Customer Quote Processing process component 2002.

If the Register Customer Requirement Deletion Notification operation 2016 is performed, a Customer Requirement Deletion Notification message 2054 is generated and sent to a Delete Provisional Customer Requirement operation 2056 that deletes provisional customer requirements that have been created by a sync check availability and reserve operation. The message 2054 may be sent on to the Customer Requirement business object 2026 using a Maintain Customer Requirement inbound process agent 2058.

Interactions Between Process Components “Due Item Processing” and “Payment Processing”

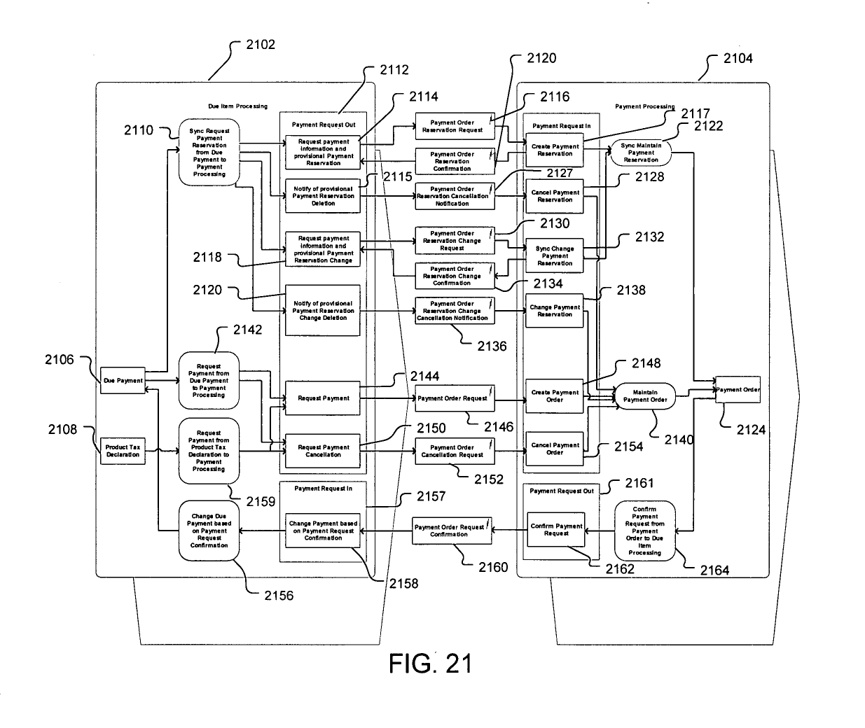

FIG. 21 is a block diagram showing interactions between a Due Item Processing process component 2102 and a Payment Processing process component 2104 in the architectural design of FIG. 1. The Due Item Processing process component 2102 may be used to manage all payables and receivables from service and supply and corresponding sales including a withholding tax. The Payment Processing process component 2104 is used to handle all incoming and outgoing payments and represent the main database for a liquidity status.

The process components include business objects to create and update data by passing messages between the Payment Request process component 2104 and the Due Item Processing process component 2102. Multiple operations can be carried out within the interfaces. Both inbound and outbound process agents carry the business object data to and from the interfaces.

A due payment business object 2106 may create payment requests manually or automatically for payment processing. The due payment business object 2106 is responsible for the payment and clearing of payables and receivables for goods and services. A product tax declaration business object 2108 is a declaration of the product tax liabilities/receivables of a company to the responsible tax authority according to the tax declaration arrangement and country specific legal requirements that triggers the payment to the tax authority.

A Synchronous Request Payment Reservation interface from Due Payment to Payment Processing outbound process component 2110 may create a payment reservation request from Due Payment. The Payment Request Out interface 2112 includes several operations which go on to create messages and updates to business objects in the Payment Processing process component 2104. The operations, messaging and business objects are discussed in the following paragraphs.

The Payment Request Out interface 2112 includes a Request payment information and provisional Payment Reservation operation 2114 that generates a Payment Order Reservation Request message 2116 to request a payment order reservation. A synchronous Create Payment Reservation operation 2117 receives the message and uses a Sync Maintain Payment Reservation inbound process agent 2122 to update a Payment Order business object 2124. In addition, a Payment Order Reservation Confirmation synchronous message 2120 is sent back to the Due Item Processing process component 2102.

The Payment Request Out interface 2112 also includes a Notify of provisional Payment Reservation Deletion operation 2115 that registers the change of a provisional payment to the last transactional/saved state. A Payment Order Reservation Cancellation Notification message 2127 maybe generated and a Cancel Payment Reservation operation 2128 may be invoked that cancels a previously sent payment reservation by reference. Next, a maintain Payment Order inbound process agent sends an update to the Payment Order business object 2124.

The Payment Request Out interface 2112 further includes a synchronous Request Payment Information and provisional Payment Reservation Change operation 2118 that requests payment information with a provisional reservation of money in payment processing. A Payment Order Reservation Change Request synchronous message 2130 is generated and a synchronous Sync Change Payment Reservation operation 2132 is invoked that changes a reservation of payment and confirms the change to the caller. Next, a Payment Reservation Confirmation synchronous message 2134 may be generated and sent back to the Due Item Processing process component 2102.

The Payment Request Out interface 2112 further includes a Notify of provisional Payment Reservation Change Deletion operation 2120 that registers the change of a provisional payment to the last transactional/saved state. A Payment Order Reservation Change Deletion Cancellation Notification message 2136 may be generated and a Change Payment Reservation operation 2138 may be invoked that changes a previously sent payment reservation by reference. Upon completion of the operation 2138, the Maintain Payment Order inbound process agent 2140 updates the Payment Order business object 2124.

A Request Payment from Due Payment to Payment Processing outbound process agent 2142 may send a payment update to the Payment Processing process component 2104 from a Due Payment business object 2106. A Request Payment operation 2144 is then invoked that sends a request for payment to Payment Processing. Upon completion of the operation, a Payment Order Request message 2146 is sent the Payment Processing process component 2104, where a Create Payment Order operation 2148 begins. Then, the Maintain Payment Order inbound process agent 2140 updates the Payment Order business object 2124 to create or cancel a payment order.

A Request Payment from Product Tax Declaration to Payment Processing outbound process agent 2159 may send an update from a Product Tax Declaration business object 2108. The update is sent into the Payment Request Out interface 2112 and a Request Payment Cancellation operation 2150 is invoked to cancel a provisional, requested or ordered payment. A Payment Order Cancellation Request message 2152 is then generated and sent to the Payment Processing process component where a Cancel Payment Order operation 2154 is invoked.

The payment order business object may use a Confirm Payment Request from Payment Order to Due Item Processing outbound process agent 2164 to confirm the processing status of a payment to the sender of a payment request. A Confirm Payment Request operation 2162 may then be invoked, thereby generating a Payment Order Request Confirmation message 2160 to send to the Due Item Processing process component 2102. The message is received in a Change payment based on Payment Request Confirmation operation 2156 that uses a Change Due Payment based on Payment Request Confirmation outbound process agent 2158 to update the processing status of Due Payment based on the confirmation of a payment request.

Interactions Between Process Components “Purchase Order Processing at Customer” and “Sales Order Processing”

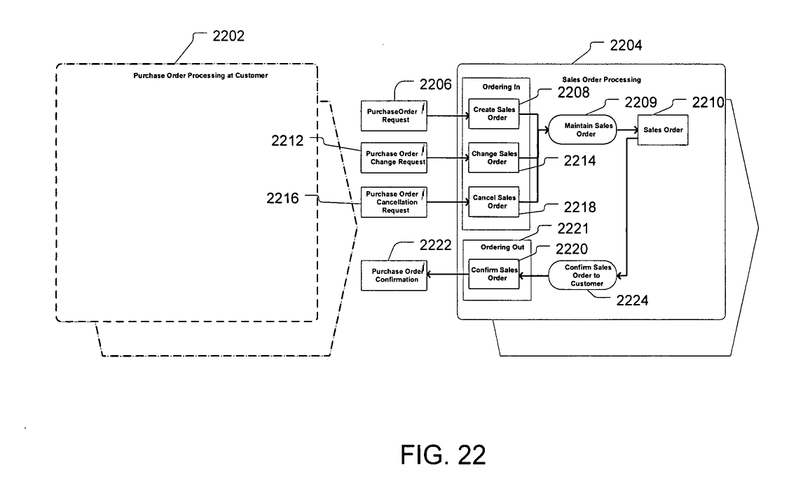

FIG. 22 is a block diagram showing interactions between a Purchase Order Processing at Customer process component 2202 and a Sales Order Processing process component 2204 in the architectural design of FIG. 1. The Sales Order Processing process component 2204 may receive one or more of four messages from the payment Order Processing at Customer process component 2202. A Purchase Order Request message 2206 may be received into a Create Sales Order operation 2208 that creates a sales order based on a new purchase order from the customer. The operation 2208 passes an update detailing the creation of the sales order using a Maintain Sales Order inbound process agent 2209 to a Sales Order business object 2210.

A Purchase Order Change Request message 2212 may be received into a Change Sales Order operation 2214 that will change a sales order based on changes in a purchase order from a customer. The operation 2214 passes an update detailing the changing of the sales order to the Sales Order business object 2210.

A Purchase Order Cancellation Request message 2216 may be received into a Cancel Sales Order operation 2218 that will cancel a sales order based on the cancellation of a purchase order from the customer. The operation 2218 passes an update detailing the cancellation of the sales order to the Sales Order business object 2210.

The Sales Order business object 2210 may invoke a Confirm Sales Order operation 2220 using a Confirm Sales Order Customer outbound process agent 2224. The operation 2220 is part of an Ordering Out interface 2221. The Confirm Sales Order operation 2220 generates and transmits a purchase Order confirmation message 2222 to the purchase Order Processing at customer process agent 2224.

Interactions Between Process Components “Customer Invoice Processing” and “Due Item Processing”

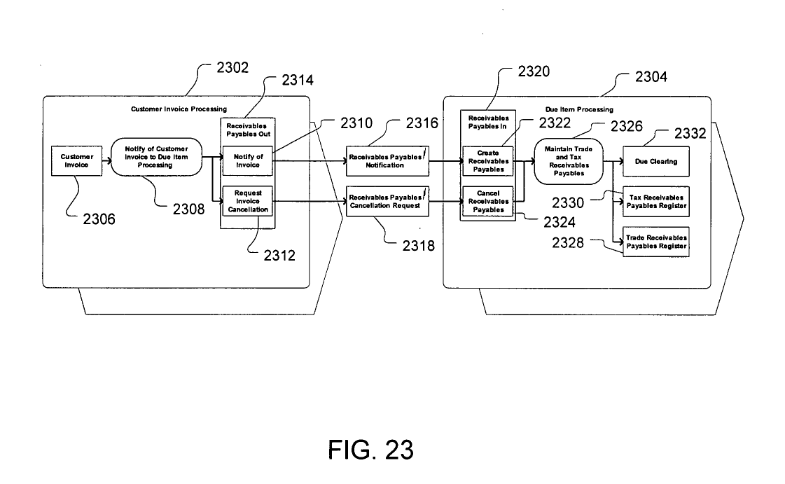

FIG. 23 is a block diagram showing interactions between a Customer Invoice Processing process component 2302 and a Due Item Processing process component 2304 in the architectural design of FIG. 1.

A Customer Invoice Processing process component 2302 includes a Customer Invoice business object 2306 which is used to charge a customer for delivery of goods or services. The Notify of Customer Invoice to Due Item Processing outbound process agent 2308 invokes a Notify of Invoice operation 2310 to notify the Due Item processing component 2304 about the receivables/payables due for the invoice that has been paid. Alternatively, a Request Invoice Cancellation operation 2312 may be invoked to cancel the previously sent notification for receivables/payables due. Both operations may be used in a Receivables Payables Out interface 2314. If the Notify of Invoice operation 2310 is invoked, then a Receivables Payables Notification message 2316 is sent to the Due Item Processing process component 2304. If the Request Invoice Cancellation operation 2312 is invoked, the Receivables/Payables Cancellation Request message 2318 is sent to the Due Item Processing process component 2304.

The Receivables/Payables Messages are received by a Receivables/Payables In interface 2320 where operations may be performed. If a notification message is received, then a Create Receivables/Payables operation 2322 is performed to create a trade and/or tax receivable or payable. If a cancellation message is received, then a Cancel Receivables/Payables operation 2324 is performed to cancel a trade and/or tax receivable or payable. Cancellations and updates may be sent by a Maintain Trade and Tax Receivables Payables inbound process agent 2326 to one or more of three business objects: a Trade Receivables Payables business object 2328, a Tax Receivables Payables business object 2330, and a Due Clearing business object 2332. The Trade Receivables Payables business object 2328 may register for all trade receivables and payables from goods and services of a company from/to its business partners. The Tax Receivables Payables business object 2330 may register for all tax receivables and payables of a company that are due for delivered goods and rendered services between buyers and sellers, the consumption of goods, and the transfer of goods that are withheld from payments to vendors. The Due Clearing business object 2332 is group of receivables and payables for clearing.

Interactions Between Process Components “Payment Processing at Business Partner” and “Payment Processing”

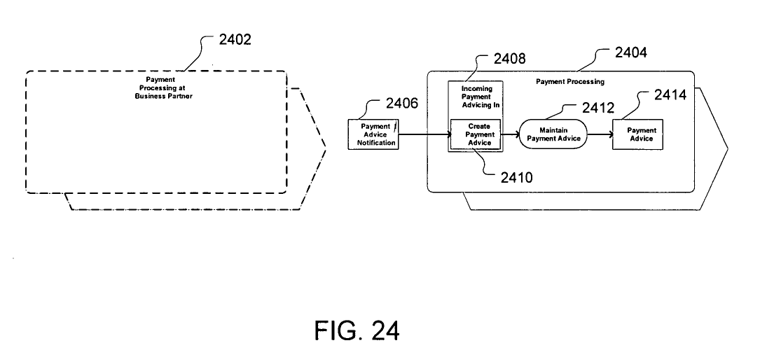

FIG. 24 is a block diagram showing interactions between a Payment Processing at Business Partner process component 2402 and a Payment Processing process component 2404 in the architectural design of FIG. 1.

The payment advice is created at a business partner and a Payment Advice Notification message 2406 is generated. The Payment Processing process component 2404 receives the Payment Advice Notification message 2406 into the Incoming Payment Advicing In interface 2408, where a Create Payment Advice operation 2410 creates a Payment Advice concerning future payment transactions. A Maintain Payment Advice inbound process agent 2412 updates the Payment Advice business object 2414 with a new or modified payment advice. The payment advice may be sent to the Due Item Processing deployment unit for post processing.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
an Outbound Delivery process component that combines tasks concerning outbound delivery processes and enables communication with a vendor and a process component within the Invoice deployment unit;
a Site Logistics Processing process component that supports all preparation and execution tasks concerning internal inventory movement in a warehouse type environment;
a Confirmation and Inventory process component that combines tasks required to confirm inventory changes and may provide services to maintain current stock, handling unit content, logistics operating unit content, and allocation content;
a Customer Requirement Processing process component that combines tasks required for processing customer requirements including receiving customer requirements, preparing them, and passing them on as supply planning requirements;
a Supply and Demand Matching process component that combines tasks necessary to ensure that sufficient material receipt elements exist to cover material demand while taking available capacity into account;
a Logistics Execution Control process component that controls and monitors the supply chain execution activities necessary for the fulfillment of an order;
a Customer Quote Processing process component that can make a legally binding offer to a customer for a delivery of goods or services according to fixed terms;
a Sales Order Processing process component that handles customers' requests for delivery of goods or services at a certain time;
a Sales Contract Processing process component that handles sales agreements that contain special negotiated conditions; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Sales Order Processing process component and the Product Valuation Accounting process component;
the Logistics Execution Control process component and the Outbound Delivery Processing process component;
the Outbound Delivery Processing process component and the Customer Invoice Processing process component;
the Sales Order Processing process component and the Customer Invoice Processing process component;
the Logistics Execution Control process component and the Site Logistics process component;
the Sales Order Processing process component and the Customer Requirement Processing process component; and
the Customer Quote Processing process component and the Customer Requirement Processing process component.

2. The product of claim 1, wherein
the plurality of process components further includes:
an Accounting process component that records all relevant business transactions;
a Due Item Processing process component that manages all payables, receivables from service and supply and corresponding sales including a withholding tax;
a Payment Processing process component that handles all incoming and outgoing payments as well as represent the main database for a liquidity status; and
a Customer Invoice Processing process component that charges a customer for the delivery of goods or services; and wherein
the pair-wise interactions between pairs of the process components further include interactions between:
the Payment Processing process component and the Accounting process component;
the Due Item Processing process component and the Accounting process component;
the Customer Invoice Processing process component and the Accounting process component;
the Sales Order Processing process component and the Accounting process component;
the Payment Processing process component and the Due Item Processing process component;
the Site Logistics Processing process component and the Accounting process component;
the Due Item Processing process component and the Payment Processing process component;
the Customer Invoice Processing process component and the Due Item Processing process component.

3. The product of claim 2, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

4. The product of claim 3, wherein the deployment units comprise:
a Financial Accounting deployment unit that includes the Accounting process component;
a Logistics Execution deployment unit that includes the Outbound Delivery process 5 component, the Site Logistics Processing process component, and the Confirmation and Inventory process component;
a Supply Chain Control deployment unit that includes the Customer Requirement Processing process component, the Supply and Demand Matching process component, and the Logistics Execution Control process component;
a Due Item Management deployment unit that includes the Due Item Processing process component;
a Payment deployment unit that includes the Payment Processing process component;
a Customer Invoice deployment unit that includes the Customer Invoice Processing process component; and
a Customer Relationship Management deployment unit that includes the Customer Quote Processing process component, the Sales Order Processing process component, and the Sales Contract Processing process component.

5. The product of claim 1, wherein:
each of the process components includes one or more business objects; and
none of the business objects of any one of the process components interacts directly with any of the business objects included in any of the other process components.

6. The product of claim 5, wherein the business objects comprise a business process object.

7. The product of claim 5, wherein:
none of the business objects included in any one of the process components is included in any of the other process components.

8. The product of claim 1, further comprising:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

9. The product of claim 8, wherein:
the inbound process agents comprise a first inbound process agent operable to start the execution of step requested in a first inbound message by creating or updating one or more business object instances.

10. The product of claim 8, wherein:
the outbound process agents comprise a first asynchronous outbound process agent that is called after a business object that is associated with the first outbound process agent changes.

11. The product of claim 1, wherein the operations comprise synchronous and asynchronous operations.

12. A system, comprising:
a computer system comprising one or more hardware platforms for executing a computer software application;
a plurality of process components, each of the process components being a package of software implementing a respective and distinct business process, the plurality of process components including:
an Outbound Delivery process component that combines tasks concerning outbound delivery processes and enables communication with a vendor and a process component within the Invoice deployment unit;
a Site Logistics Processing process component that supports all preparation and execution tasks concerning internal inventory movement in a warehouse type environment;
a Confirmation and Inventory process component that combines tasks required to confirm inventory changes and may provide services to maintain current stock, handling unit content, logistics operating unit content, and allocation content;
a Customer Requirement Processing process component that combines tasks required for processing customer requirements including receiving customer requirements, preparing them, and passing them on as supply planning requirements;
a Supply and Demand Matching process component that combines tasks necessary to ensure that sufficient material receipt elements exist to cover material demand while taking available capacity into account;
a Logistics Execution Control process component that controls and monitors the supply chain execution activities necessary for the fulfillment of an order;
a Customer Quote Processing process component that can make a legally binding offer to a customer for a delivery of goods or services according to fixed terms;
a Sales Order Processing process component that handles customers' requests for delivery of goods or services at a certain time;
a Sales Contract Processing process component that handles sales agreements that contain special negotiated conditions; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Sales Order Processing process component and the Product Valuation Accounting process component;
the Logistics Execution Control process component and the Outbound Delivery Processing process component;
the Outbound Delivery Processing process component and the Customer Invoice Processing process component;
the Sales Order Processing process component and the Customer Invoice Processing process component;
the Logistics Execution Control process component and the Site Logistics process component;
the Sales Order Processing process component and the Customer Requirement Processing process component; and
the Customer Quote Processing process component and the Customer Requirement Processing process component.

13. The system of claim 12, wherein:
each of the process components includes one or more business objects; and
none of the business objects of any one of the process components interacts directly with any of the business objects included in any of the other process components.

14. The system of claim 12, wherein:
none of the business objects included in any one of the process components is included in any of the other process components.

15. The system of claim 12, wherein:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

16. The system of claim 12, the system comprising multiple hardware platforms, wherein:
the Outbound Delivery process component, the Site Logistics Processing process component, and the Confirmation and Inventory process component are deployed on a first hardware platform;
the Customer Requirement Processing process component, the Supply and Demand Matching process component, and the Logistics Execution Control process component are deployed on a second hardware platform;
the Customer Quote Processing process component, the Sales Order Processing process component, and the Sales Contract Processing process component are deployed on a third hardware platform.

17. The system of claim 16, wherein each of the first through the third hardware platforms are distinct and separate from each other.

18. A method for developing a computer software application, comprising:
obtaining in a computer system digital data representing an architectural design for a set of processes implementing an end-to-end application process, the design specifying a process component for each process in the set of processes, the design specifying further specifying a set of process component interactions, wherein
the specified process components include
an Outbound Delivery process component that combines tasks concerning outbound delivery processes and enables communication with a vendor and a process component within the Invoice deployment unit;
a Site Logistics Processing process component that supports all preparation and execution tasks concerning internal inventory movement in a warehouse type environment;
a Confirmation and Inventory process component that combines tasks required to confirm inventory changes and may provide services to maintain current stock, handling unit content, logistics operating unit content, and allocation content;
a Customer Requirement Processing process component that combines tasks required for processing customer requirements including receiving customer requirements, preparing them, and passing them on as supply planning requirements;
a Supply and Demand Matching process component that combines tasks necessary to ensure that sufficient material receipt elements exist to cover material demand while taking available capacity into account;
a Logistics Execution Control process component that controls and monitors the supply chain execution activities necessary for the fulfillment of an order;
a Customer Quote Processing process component that can make a legally binding offer to a customer for a delivery of goods or services according to fixed terms;
a Sales Order Processing process component that handles customers' requests for delivery of goods or services at a certain time;
a Sales Contract Processing process component that handles sales agreements that contain special negotiated conditions; and wherein
the process component interactions include interactions between
the Sales Order Processing process component and the Product Valuation Accounting process component;
the Logistics Execution Control process component and the Outbound Delivery Processing process component;
the Outbound Delivery Processing process component and the Customer Invoice Processing process component;
the Sales Order Processing process component and the Customer Invoice Processing process component;
the Logistics Execution Control process component and the Site Logistics process component;
the Sales Order Processing process component and the Customer Requirement Processing process component; and
the Customer Quote Processing process component and the Customer Requirement Processing process component; and
using the design including the specified process components and the specified process component interactions to develop a computer software application to perform the set of processes.

19. The method of claim 18, wherein:
each process in the set of processes is a business process transforming a defined business input into a defined business outcome.

20. The method of claim 19, wherein:
obtaining digital data representing the architectural design further comprises editing the design before using the design.
